(19) United States
(12) Patent Application Publication
(10) Pub. No.: US 2024/0022685 A1
(43) Pub. Date: Jan. 18, 2024

(54) METHOD FOR GENERATING ON-THE-BEAT VIDEO AND ELECTRONIC DEVICE

(71) Applicant: BEIJING DAJIA INTERNET INFORMATION TECHNOLOGY CO., LTD., Beijing (CN)

(72) Inventor: Peng WANG, Beijing (CN)

(21) Appl. No.: 18/352,544

(22) Filed: Jul. 14, 2023

(30) Foreign Application Priority Data
Jul. 15, 2022 (CN) 202210835909.3

(51) Int. Cl. H04N 7/01; G06T 7/20; G06V 10/25; H04N 21/43; H04N 21/81; H04N 21/845

(52) U.S. Cl. CPC H04N 7/013; G06T 7/20; G06V 10/25; H04N 21/43074; H04N 21/8113; H04N 21/8456; G06T 2207/20084

(57) ABSTRACT

A method for generating an on-the-beat video is provided. The method includes: acquiring a first video and preset music; determining at least one target beat moment in the preset music; performing key motion recognition on the first video to determine at least one key motion image of the first video; performing speed adjustment on the first video to obtain a second video; and adding the preset music to the second video to obtain a target on-the-beat video.

### CROSS-REFERENCE TO RELATED APPLICATIONS

This application is based on and claims priority to Chinese Patent Application No. 202210835909.3, filed on Jul. 15, 2022, the disclosure of which is herein incorporated by reference in its entirety.

### TECHNICAL FIELD

The present disclosure relates to the field of Internet technologies, in particular to a method for generating an on-the-beat video and an electronic device.

### BACKGROUND OF THE INVENTION

With the rapid development of mobile Internet, on-the-beat videos have been favored by more and more people. The technology for generating the on-the-beat video refers to a video technology that generates the video of which pictures match a rhythm of music, so that the pictures can be smoothly switched at beat moments of music.

### SUMMARY OF THE INVENTION

The present disclosure provides a method for generating an on-the-beat video and an electronic device.

According to an aspect of embodiments of the present disclosure, a method for generating an on-the-beat video is generated and includes:
acquiring a first video and preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

According to another aspect of the embodiments of the present disclosure, an electronic device is provided and includes: a processor, and a memory for storing instructions executable by the processor; wherein the processor is configured to execute the instructions to implement the following steps:
acquiring a first video and preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

According to another aspect of the embodiments of the present disclosure, a computer-readable storage medium is provided. Instructions in the storage medium, when executed by a processor of an electronic device, enable the electronic device to be capable of executing the following steps:
acquiring a first video and preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

According to another aspect of the embodiments of the present disclosure, a computer program product containing instructions is provided. The computer program product, when running on a computer, enables the computer to execute the following steps:
acquiring a first video and preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

### BRIEF DESCRIPTION OF DRAWINGS

The accompanying drawings incorporated in the description and forming a part thereof illustrate the embodiments according to the present disclosure and are configured to explain principles of the present disclosure along with the description, without limiting the present disclosure improperly.

FIG. 1 is a schematic diagram of an application environment according to some embodiments;

FIG. 2 is a flowchart of a method for generating an on-the-beat video according to some embodiments;

FIG. 3 is a flowchart of performing key motion recognition on a first video to determine at least one key motion image of the first video according to some embodiments;

FIG. 4 is a flowchart of performing speed adjustment on a first video according to some embodiments;

FIG. 5 is a flowchart of performing speed adjustment on a video segment according to some embodiments;

FIG. 6 is a block diagram of an apparatus for generating an on-the-beat video according to some embodiments;

FIG. 7 is a block diagram of an electronic device for generating an on-the-beat video according to some embodiments; and

FIG. 8 is a block diagram of an electronic device for generating an on-the-beat video according to some embodiments.

### DETAILED DESCRIPTION

It should be noted that user information (including but not limited to user equipment information, user personal information, etc.) and data (including but not limited to data for display, data for analysis, etc.) involved in the present disclosure are all information and data authorized by users or fully authorized by all parties.

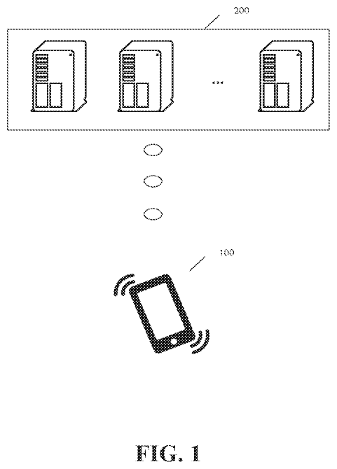

Please refer to FIG. 1, which is a schematic diagram of an application environment according to some embodiments, and the application environment includes a terminal 100 and servers 200.

In some embodiments, the terminal 100 may be configured to provide services of editing and creating videos for each user. Specifically, the terminal 100 may include, but not limited to, a smart phone, a desktop computer, a tablet computer, a notebook computer, a smart speaker, a digital assistant, an augmented reality (AR)/virtual reality (VR) device, a smart wearable device and other types of electronic devices, and may also be software running on the above electronic devices, such as application programs. Optionally, an operating system running on the electronic device may include but not limited to Android system, IOS system, linux, windows, etc.

In some embodiments, the server 200 may provide background services for the terminal 100. Specifically, the server 200 may be an independent physical server, may also be a server cluster composed of multiple physical servers or a distributed system, and may also be a cloud server providing cloud computing services.

In addition, it should be noted that FIG. 1 only shows one application environment according to the present disclosure, and other application environments may be included in practical application.

In the embodiments of the description, the above terminal 100 and server 200 may be directly or indirectly connected by means of wired or wireless communication, which is not limited by the present disclosure.

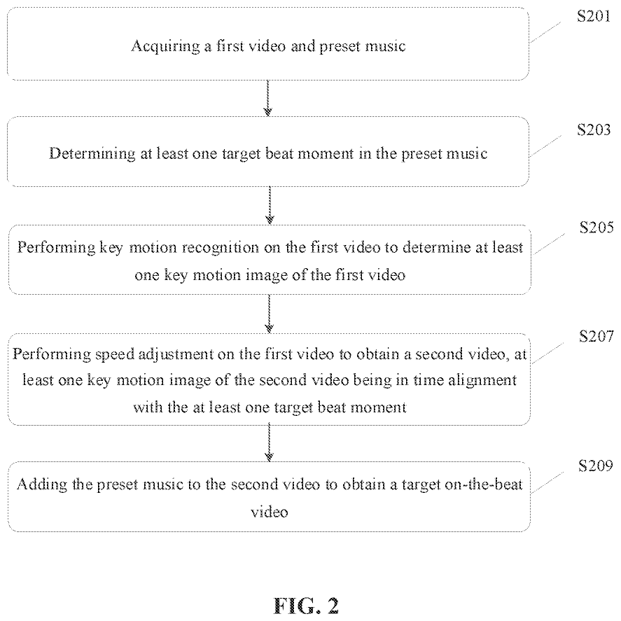

FIG. 2 is a flowchart of a method for generating an on-the-beat video according to some embodiments. As shown in FIG. 2, the method for generating an on-the-beat video may be used in an electronic device such as a terminal or server, and includes the following steps S201 to S209.

In step S201, a first video and preset music are acquired.

In some embodiments, the first video is a video including a moving object. Optionally, the moving object is a person, an animal, a vehicle, an aircraft, etc. The preset music is music that needs to be synthesized with the first video.

In practical application, the terminal may provide a video editing page. Accordingly, the user may import the pre-collected first video based on the video editing page. Optionally, the preset music may be music pre-collected by the user. Accordingly, the user may import the preset music through the video editing page. Optionally, the preset music may be certain template music selected by the user from a large number of template music provided by a video editing platform. Accordingly, the user may select certain template music on a page showing the large number of template music, so as to import the selected template music to the video editing page. Specifically, the template music may include a preset rhythm mark. The preset rhythm mark may be preset.

In step S203, at least one target beat moment in the preset music is determined.

In some embodiments, after the user imports the first video and the preset music, the execution of an on-the-beat video generation process may be automatically triggered; the user may also trigger an on-the-beat video generation instruction in the case that the user imports the first video and the preset music, so as to carry out the execution of the on-the-beat video generation process. For example, when the user clicks the button of “generating an on-the-beat with one click” on the video editing page, the terminal executes the on-the-beat video generation process based on the first video and the preset music which are imported by the user.

In some embodiments, the above determining at least one target beat moment in the preset music includes:
acquiring an energy waveform of the preset music; and
determining, based on the energy waveform, at least one target beat moment.

The above energy waveform represents loudness information of the preset music. For example, the point corresponding to a peak in the energy waveform is taken as at least one target beat moment. Accordingly, the at least one target beat moment may be the point corresponding to the peak in the energy waveform corresponding to the preset music.

In the above embodiment, the at least one target beat moment in the preset music can be quickly and automatically recognized by acquiring the energy waveform representing the loudness information of the preset music, thereby greatly improving the recognition efficiency and accuracy of the target beat moment for an on-the-beat.

In some embodiments, the above method further includes:
displaying the energy waveform, wherein the energy waveform includes mark information of at least one target beat moment; and
updating, in response to an update instruction for the mark information of any target beat moment, the target beat moment corresponding to the update instruction in the at least one target beat moment.

The energy waveform may be a waveform with a playing time schedule of the preset music as the abscissa and the loudness information of the preset music as the ordinate. Optionally, the user may trigger the above update instruction by means of moving the mark information and the like, and then the terminal may update the point corresponding to the moved mark information as the target beat moment.

In the above embodiment, by displaying the energy waveform including the mark information corresponding to at least one target beat moment, a user can conveniently update the target beat moment according to actual needs, and the effectiveness of selecting the target beat moment is improved.

In some embodiments, in the case that the above preset music is the template music including a preset rhythm mark, the step of determining at least one target beat moment in the preset music includes: determining at least one target beat moment based on the preset rhythm mark.

In some embodiments, the preset rhythm mark may be the mark of at least one target beat moment in the template music. The template music may be pre-produced by relevant producers. Optionally, in the process of producing the template music, the beat moments may be automatically recognized and marked first, and then the template music is generated by the relevant producers after adjustment according to actual needs. Optionally, if the automatically recognized beat moments are accurate, the relevant producers may also directly skip the adjustment step and directly trigger the operation of confirming generation of the template music.

In the above embodiment, in the case that the preset music is the template music including the preset rhythm mark, at least one target beat moment in the preset music can be quickly and automatically recognized in combination with the preset rhythm mark, thereby greatly improving the recognition efficiency and accuracy of the target beat moment for the on-the-beat.

In step S205, key motion recognition is performed on the first video to determine at least one key motion image of the first video.

In some embodiments, the at least one key motion image may be a video image where the key motion in the first video is located. The key motion may be a key motion in the moving process of the moving object. The key motion may be different in different sports scenarios. For example, in a boxing scenario, the key motion may be an ending action of punching.

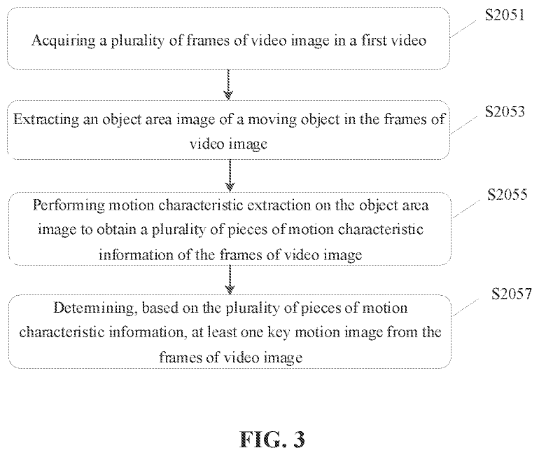

In some embodiments, the key motion recognition is used to recognize the key motion of the moving object in the first video, and the key motion has a preset motion characteristic. As shown in FIG. 3, performing key motion recognition on the first video to determine at least one key motion image of the first video includes the following steps S2051 to S2057.

In step S2051, a plurality of frames of video image of the first video is acquired.

In step S2053, an object area image of the moving object in the frames of video image is extracted.

In step S2055, the object area image is subjected to key motion extraction to obtain a plurality of pieces of motion characteristic information of the frames of video image.

In step S2057, based on the plurality of pieces of motion characteristic information, at least one key motion image is determined from the frames of video image.

In some embodiments, the terminal may extract the object area image of the moving object from the frames of video image by means of a target detection technology and the like. The object area image is an area where the moving object is located in the video image, and is configured to indicate a position of the moving object in the video image. Optionally, the terminal may extract the motion characteristic information of each frame video image from the object area image in combination with a neural network and the like. The motion characteristic information is configured to determine whether the action of the moving object is a key motion.

In some embodiments, the terminal may sequentially analyze changes of the corresponding motion characteristic information according to a time sequence of the frames of video image, and take the video image corresponding to the ending action of a certain action as the key motion image in combination with the changes.

In some other embodiments, in some scenarios where a moving type corresponding to the video is preset, the terminal may acquire standard key motion feature information corresponding to the moving type in advance. Accordingly, the terminal may calculate a similarity between the plurality of pieces of motion characteristic information and the standard key motion feature information. The terminal takes the video images having the preset number corresponding to the motion characteristic information with the similarity greater than or equal to a preset threshold, or with greater similarity, as at least one key motion image.

In the above embodiment, by extracting the object area image of the moving object from the frames of video image of the first video and further extracting the motion characteristic information, the interference of background features can be avoided while effectively extracting the motion characteristic, so that the effectiveness of determining the at least one key motion image for the on-the-beat in combination with the motion characteristic information can be ensured.

In step S207, speed adjustment is performed on the first video to obtain a second video, and at least one key motion image of the second video is in time alignment with the at least one target beat moment.

In some embodiments, the second video is a speed variation video corresponding to the first video, and the speed variation video corresponding to the first video may be a video after speed adjustment is performed on the first video. By the speed adjustment on the first video, the terminal enables a playing time length of the speed variation video to be consistent with the playing time length of the preset music, and playing progress time of at least one key motion image in the speed variation video to be consistent with the playing progress time of at least one target beat moment in the preset music.

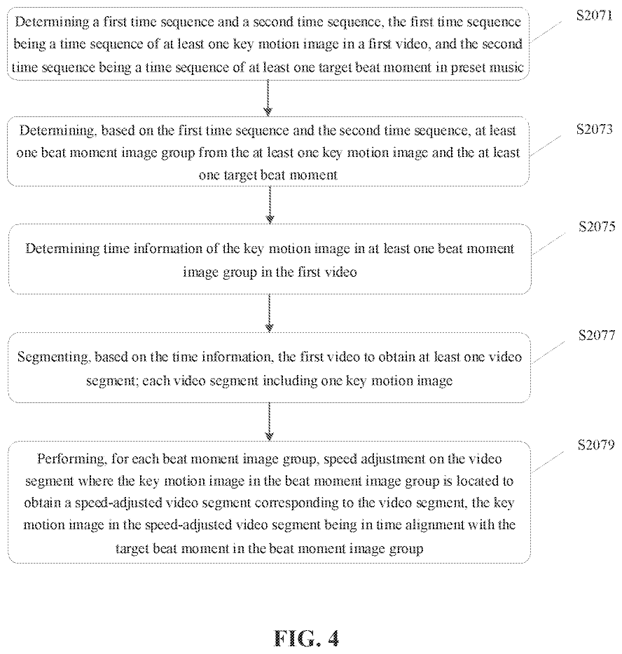

In some embodiments, the above speed variation video includes speed-adjusted video segments corresponding to a plurality of video segments in the first video respectively. As shown in FIG. 4, performing speed adjustment on the first video to obtain the second video includes the following steps S2071 to S2079.

In step S2071, a first time sequence and a second time sequence are determined, the first time sequence is a time sequence of at least one key motion image of the first video, and the second time sequence is a time sequence of at least one target beat moment in the preset music.

In step S2073, based on the first time sequence and the second time sequence, at least one beat moment image group is determined from the at least one key motion image and the at least one target beat moment, and each beat moment image group includes at least one target beat moment and at least one key motion image which are in one-to-one correspondence.

In step S2075, time information of the key motion image in the at least one beat moment image group in the first video is determined.

In step S2077, based on the time information, the first video is segmented to obtain at least one video segment; each video segment includes one key motion image.

In step S2079, for each beat moment image group, the video segment where the key motion image in the beat moment image group is located is subjected to speed adjustment to obtain the speed-adjusted video segment corresponding to the video segment, and the key motion image in the speed-adjusted video segment is in time alignment with the target beat moment in the beat moment image group.

In some embodiments, the above first time sequence may be a sequence generated based on the playing progress time of the at least one key motion image of the first video. The second time sequence may be a sequence generated based on the playing progress time of the at least one target beat moment in the preset music. Optionally, in the above generation process of the first time sequence and the second time sequence, the sequencing may be performed from early to late according to the playing progress time, or may be performed from late to early according to the playing progress time.

In some embodiments, the number of at least one target beat moment is a first number, and the number of at least one key motion image is a second number. The first number may be equal to the second number. Accordingly, determining, by the terminal, the at least one beat moment image group from the at least one key motion image and the at least one target beat moment based on the first time sequence and the second time sequence includes: dividing the key motion image and the target beat moment with the same time sequence into the same beat moment image group according to the first time sequence and the second time sequence.

In some embodiments, when the first number is less than the second number, the number of at least one beat moment image group may be the first number. The above method may further include: according to the first time sequence, screening out key motion images that have the first number and come first in the first time sequence from the at least one key motion image.

Correspondingly, determining at least one beat moment image group from the at least one key motion image and the at least one target beat moment based on the first time sequence and the second time sequence includes: grouping the key motion images having the first number and corresponding target beat moments having the first number to obtain beat moment image groups having the first number according to the first time sequence and the second time sequence.

For example, if the first number (i.e., the number of target beat moments) is 5 and the second number (i.e., the number of key motion images) is 7, then the number of beat moment image groups is 5. According to the first time sequence, the terminal screens out 5 key motion images that come first in the first time sequence from 7 key motion images. Then, the 5 key motion images obtained from the screening and the 5 target beat moments are divided into the same beat moment image group.

In some embodiments, the terminal may select one key motion image from key motion images having the first number from front to back according to the first time sequence, and then divide the selected key motion image and the target beat moment into the same beat moment image group in combination with one target beat moment selected from target beat moments having the first number from front to back in the second time sequence.

In the above embodiment, when the number of at least one target beat moment is less than the number of at least one key motion image, key motion images that have the first number and come first in the time sequence are selected from key motion images such that the number of key motion images matches the number of target beat moment, which can ensure a success rate of subsequently generating the on-the-beat video.

In some embodiments, when the first number is less than the second number, the number of at least one beat moment image group is equal to the first number. The above method also includes: performing motion analysis on key motion images having the second number to obtain a motion analysis result, wherein the motion analysis result represents an motion exciting level of key motion images having the second number; and based on the motion analysis result, filtering key motion images having the second number to obtain key motion images having the first number.

Correspondingly, determining at least one beat moment image group from the at least one key motion image and the at least one target beat moment based on the first time sequence and the second time sequence includes: grouping the key motion images having the first number and corresponding target beat moments having the first number to obtain beat moment image groups having the first number according to the first time sequence and the second time sequence.

In some embodiments, the motion analysis result may be index data of the motion exciting level of key motion images having the second number. Accordingly, the terminal may filter key motion images having the first number with larger index data from key motion images having the second number in combination with the index data. Larger index data represent a larger exciting level. Optionally, the terminal may perform motion analysis in combination with a pre-trained motion analysis model. Optionally, the motion analysis model may be acquired by performing motion analysis training on a preset deep learning model based on a sample action images and a preset motion analysis result of the sample action images in advance. The preset motion analysis result refers to the preset index data representing the motion exciting level of the sample action images.

In some embodiments, the terminal may sequentially select one key motion image from key motion images having the first number from front to back according to the first time sequence. Then the terminal sequentially selects one target beat moment from target beat moments having the first number from front to back in combination with the second time sequence. Finally, the terminal divides the selected key motion image and target beat moment into the same beat moment image group.

In the above embodiment, when the number of at least one target beat moment is less than the number of at least one key motion image, the motion analysis result capable of representing the motion exciting level corresponding to key motion images having the second number is acquired by performing motion analysis on key motion images having the second number. In addition, the terminal selects key motion images having the first number from key motion images having the second number in combination with the motion analysis results, which can effectively ensure that the number of target beat moments for the on-the-beat and the number of key motion images are consistent, and can better improve the exciting level or the wonderful degree of the key motion images for the on-the-beat, thereby ensuring a success rate of subsequently generating the on-the-beat video and an on-the-beat effect.

In some embodiments, when the first number (i.e., the number of target beat moments) is greater than the second number (i.e., the number of key motion images), the number of at least one beat moment image group is the second number. The above method may further include: according to the second time sequence, screening out target beat moments having the second number with the front time sequence from at least one target beat moment. Accordingly, determining at least one beat moment image group from the at least one key motion image and the at least one target beat moment based on the first time sequence and the second time sequence may include: grouping key motion images having the second number and target beat moments having the second number according to the first time sequence and the second time sequence to obtain beat moment image groups having the second number.

In some embodiments, the terminal may sequentially select one target beat moment from target beat moments having the second number from front to back according to the second time sequence. Then the terminal sequentially selects one key motion image from key motion images having the second number from front to back in combination with the first time sequence. Finally, the terminal divides the selected target beat moment and key motion image into the same beat moment image group.

In the above embodiment, when the number of at least one target beat moment (i.e., the first number) is greater than the number of at least one key motion image (i.e., the second number), target beat moments having the second number are selected from target beat moments according to the time sequence such that the number of target beat moments matches the number of key motion image, which can ensure a success rate of subsequently generating the on-the-beat video.

In some embodiments, when the number of at least one target beat moment is greater than the number of at least one key motion image, the terminal may feed back to the user the prompt information that the video needs to be uploaded again since there are too few key motion images.

In some embodiments, after determining at least one beat moment image group, the terminal may determine time information of the key motion image in the at least one beat moment image group in the first video. The time information of the key motion image of the first video may be the playing progress time of the key motion image of the first video.

In some embodiments, the terminal may segment the key motion image into the previous video segment in the process of segmenting the first video in combination with the time information of the key motion image in at least one beat moment image group. For example, the time information of the key motion image in the first beat moment image group is the fifth second in the first video. Optionally, 0-5 s (including 5 s) may be used as the first video segment, and accordingly, the next video segment starts from the sixth second.

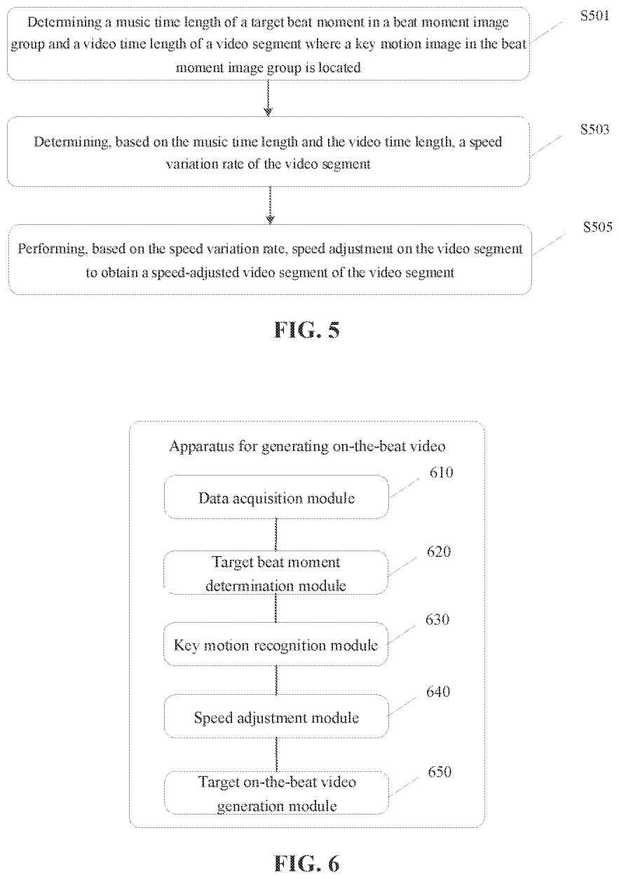

In some embodiments, as shown in FIG. 5, performing speed adjustment on the video segment where the key motion image in the beat moment image group is located to obtain the speed-adjusted video segment of the video segment includes the following steps S501 to S503.

In step S501, a music time length of the target beat moment in the beat moment image group and a video time length of the video segment where the key motion image in the beat moment image group is located are determined.

In step S503, based on the music time length and the video time length, a speed variation rate of the video segment is determined.

In step S505, based on the speed variation rate, the speed adjustment is performed on the video segment to obtain the speed-adjusted video segment of the video segment.

In some embodiments, the music time length of any target beat moment may be the music time length between the target beat moment and the last target beat moment. Optionally, if the certain target beat moment is a first target beat moment in the preset music, accordingly, the music time length of the first target beat moment may be the time length from start time of the preset music to playing progress time of the first target rhythm.

In some embodiments, the terminal may take a ratio of the video time length of any video segment to the music time length as the speed variation rate of the video segment.

In some embodiments, the terminal may perform speed adjustment on the video segment based on the speed variation rate of each video segment to obtain the speed-adjusted video segment of the video segment.

In some embodiments, performing speed adjustment on the video segment based on the speed variation rate to obtain the speed-adjusted video segment of the video segment includes: generating an initial speed variation curve of the video segment based on the speed variation rate; smoothing the initial speed variation curve to obtain target speed variation curves of a plurality of video segments; and based on the target speed variation curves, performing speed adjustment on the video segment to obtain the speed-adjusted video segment of the video segment.

In some embodiments, the initial speed variation curve of any above video segment may be a Bezier curve with an average speed variation rate equal to the speed variation rate of the video segment. Optionally, by displaying the initial speed variation curves of a plurality of video segments at the terminal, the initial speed variation curves are smoothed by the user through moving the curves. Optionally, the initial speed variation curves are smoothed by calculating curve slopes at adjacent positions of the plurality of initial speed variation curves and adjusting the curve slopes.

In the above embodiment, each of the speed variation rates of the plurality of video segments is determined in combination with the music time length of the target beat moment in at least one beat moment image group and the video time length of the video segment where the key motion image in at least one beat moment image group is located, and then the speed adjustment may be performed on the plurality of video segments based on the speed variation rates, so that the target beat moment and the key motion image in at least one beat moment image group for the on-the-beat are in time alignment, and the accuracy of the on-the-beat is improved. Moreover, the smoothness between the speed variation curves of the plurality of video segments can be effectively improved by smoothing the initial speed variation curves of the speed variation rates, and then the smoothness in the subsequent playing process of a target on-the-beat video generated based on the plurality of video segments can be improved.

In the above embodiment, the at least one beat moment image group for the on-the-beat is determined from the at least one key motion image and the at least one target beat moment in combination with the first time sequence and the second time sequence, and the first video is segmented in combination with the time information of the key motion image in the at least one beat moment image group, which can facilitate the segmenting speed adjustment, so as to better perform time alignment on the target beat moment and the key motion image in the same beat moment image group and improve the accuracy of the on-the-beat.

In step S209, the preset music is added to the second video to obtain the target on-the-beat video.

In some embodiments, the terminal may synthesize the second video and the preset music to obtain the above target on-the-beat video. In the case that the second video includes the speed-adjusted video segments of a plurality of video segments in the first video, the plurality of speed-adjusted video segments may be spliced and synthesized with the preset music to obtain the target on-the-beat video.

In some embodiments, the method for generating an on-the-beat video according to the embodiment of the present disclosure is executed by the terminal and includes the following steps:
acquiring a video to be processed and preset music;
determining at least one target beat moment in the preset music;
performing key motion recognition on the video to be processed to determine at least one key motion image in the video to be processed;
aligning, based on speed adjustment on the video to be processed, the at least one key motion image with time corresponding to the at least one target beat moment to obtain a speed variation video corresponding to the video to be processed; and
generating a target on-the-beat video based on the speed variation video and the preset music.

In some embodiments, the speed variation video includes speed-adjusted video segments corresponding to a plurality of video segments in the video to be processed respectively; and aligning, based on the speed adjustment on the video to be processed, the at least one key motion image with the time corresponding to the at least one target beat moment to obtain the speed variation video corresponding to the video to be processed includes:
determining a first time sequence of the at least one key motion image in the video to be processed and a second time sequence of the at least one target beat moment in the preset music;
determining, based on the first time sequence and the second time sequence, at least one beat moment image group from the at least one key motion image and the at least one target beat moment, each beat moment image group including at least one target beat moment and at least one key motion image which are in one-to-one correspondence;
determining time information of the key motion image in the at least one beat moment image group in the video to be processed;
performing, based on the time information, segmentation processing on the video to be processed to obtain the plurality of video segments; each video segment including one key motion image; and
aligning, based on the speed adjustment on the plurality of video segments, the target beat moment and the time corresponding to the key motion diagram in the at least one beat moment image group to obtain the speed-adjusted video segments corresponding to the plurality of video segments respectively.

In some embodiments, aligning, based on the speed adjustment on the plurality of video segments, the target beat moment and the time corresponding to the time corresponding to the key motion image in the at least one beat moment image group to obtain the speed-adjusted video segments corresponding to the plurality of video segments respectively includes:
determining a music time length corresponding to the target beat moment in the at least one beat moment image group and a video time length of the video segment where the key motion image in the at least one beat moment image group is located;
determining, based on the music time length and the video time length, speed variation rates corresponding to the plurality of video segments respectively; and
performing, based on the speed variation rates, speed adjustment on the plurality of video segments to obtain the speed-adjusted video segments corresponding to the plurality of video segments respectively.

In some embodiments, performing, based on the speed variation rates, the speed adjustment on the plurality of video segments to obtain the speed-adjusted video segments corresponding to the plurality of video segments respectively includes:
generating, based on the speed variation rates, initial speed variation curves corresponding to the plurality of video segments respectively;
smoothing the initial speed variation curves to obtain target speed variation curves corresponding to the plurality of video segments; and
performing, based on the target speed variation curves, speed adjustment on the plurality of video segments to obtain the speed-adjusted video segments corresponding to the plurality of video segments respectively.

In some embodiments, when the number of the at least one target beat moment (i.e., the first number) is less than the number of the at least one key motion image (i.e., the second number), the at least one beat moment image group is the beat moment image groups having the first number; the method further includes:
screening out, according to the first time sequence, key motion images that have the first number and come first in the first time sequence from the at least one key motion image.

Determining, based on the first time sequence and the second time sequence, at least one beat moment image group from the at least one key motion image and the at least one target beat moment includes:
grouping, according to the first time sequence and the second time sequence, the key motion images having the first number and corresponding target beat moments having the first number to obtain beat moment image groups having the first number.

In some embodiments, when the number of the at least one target beat moment (i.e., the first number) is less than the number of the at least one key motion image (i.e., the second number), the at least one beat moment image group is the beat moment image groups having the first number; the method further includes:
performing motion analysis on key motion images having the second number to obtain a motion analysis result, the motion analysis result representing an motion exciting level corresponding to key motion images having the second number; and
filtering, based on the motion analysis result, key motion images having the second number to obtain key motion images having the first number.

Determining, based on the first time sequence and the second time sequence, at least one beat moment image group from the at least one key motion image and the at least one target beat moment includes:
grouping, according to the first time sequence and the second time sequence, key motion images having the first number and target beat moments having the first number to obtain beat moment image groups having the first number.

In some embodiments, when the number of the at least one target beat moment (i.e., the first number) is greater than the number of the at least one key motion image (i.e., the second number), the at least one beat moment image group is the beat moment image groups having the second number; the method further includes:
screening out, according to the second time sequence, target beat moments that have the second number and come first in the second time sequence from the at least one target beat moment.

Determining, based on the first time sequence and the second time sequence, at least one beat moment image group from the at least one key motion image and the at least one target beat moment includes:
grouping, according to the first time sequence and the second time sequence, key motion images having the second number and corresponding target beat moments to obtain beat moment image groups having the second number.

In some embodiments, the preset music is template music including a preset rhythm mark, and determining at least one target beat moment in the preset music includes:
determining, based on the preset rhythm mark, the at least one target beat moment.

In some embodiments, determining at least one target beat moment in the preset music includes:
acquiring an energy waveform corresponding to the preset music, the energy waveform representing loudness information of the preset music; and
determining, based on the energy waveform, the at least one target beat moment.

In some embodiments, the method further includes:
displaying the energy waveform, the energy waveform including mark information corresponding to the at least one target beat moment; and
updating, in response to an update instruction for the mark information corresponding to any target beat moment, the target beat moment corresponding to the update instruction in the at least one target beat moment.

In some embodiments, performing key motion recognition on the video to be processed to determine at least one key motion image in the video to be processed includes:
acquiring a plurality of frames of video image in the video to be processed;
extracting an object area image corresponding to a moving object in the frames of video image;
performing motion characteristic extraction on the object area image to obtain a plurality of pieces of motion characteristic information corresponding to the frames of video image; and
determining, based on the plurality of pieces of motion characteristic information, the at least one key motion image from the frames of video image.

It can be seen from the above technical solutions according to the embodiments of the description that in the process of generating the on-the-beat video, by automatically determining the target beat moment in the preset music and by recognizing the key motion of the first video, the automatically recognized at least one key motion image of the first video is taken as a video image for the on-the-beat, so that the convenience of video production is greatly improved, and the adaptability between the on-the-beat beat moment and the on-the-beat video image is effectively improved. Then, based on the speed adjustment on the first video (i.e., to be processed video), the at least one key motion image is aligned with the time corresponding to at least one target beat moment, and the target on-the-beat video is generated based on the speed variation video and the preset music, which can effectively improve the on-the-beat effect on the basis of improving the production efficiency of the on-the-beat video.

In some embodiments, a method for generating an on-the-beat video is provided. The method is implemented in an electronic device or a terminal. The method comprising: acquiring a first video and acquiring preset music in response to import, by a user, on a video editing page displayed on the electronic device; determining at least one target beat moment in the preset music in response to a user's operation on mark information on the preset music or determined automatically based on a music template; identifying at least one key motion image of the first video by a neural network trained to recognize key motion image; determining at least one beat moment image group from the at least one target beat moment in the preset music and the at least one key motion image in the first video based on a number of target beat moments in the preset music and a number of key motion images in the first video such that one target beat moment corresponds one key motion image, wherein a number of the at least one beat moment image group is equal to the smaller one of the number of target beat moments in the preset music and the number of key motion images in the first video; adjusting a speed of the first video such that the at least one key motion image in the at least one beat moment image group is in time alignment with the at least one target beat moment in the at least one beat moment image group; and adding the preset music to the adjusted first video to obtain the on-the-beat video.

In some embodiments, a first video (i.e., to be processed video) and preset music may be acquired by importing the first video and the preset music by a user on a video editing page displayed on an electronic device. After the user imports the first video and the preset music, the execution of an on-the-beat video generation process are automatically triggered by an activation of a control on the video editing page or may be automatically triggered after importing the first video and the preset music. In some examples, the key motion images are identified by a neural network, and the target beat moments to be matched with the key motion images are selected by a user in an easy and convenient manner such as simply operating on a mark on an energy waveform of the preset music or operating on a rhythm mark on a template music. In this way, a user can produce a satisfactory on-the-beat video even if the user is not experienced at the making a video.

FIG. 6 is a block diagram of an apparatus for generating an on-the-beat video according to some embodiments. Referring to FIG. 6, the apparatus includes:
a data acquisition module 610 configured to obtain a first video and preset music;
a target beat moment determination module 620 configured to determine at least one target beat moment in the preset music;
a key motion recognition module 630 configured to perform key motion recognition on the first video to determine at least one key motion image of the first video, wherein the key motion recognition is used to recognize a key motion of a moving object in the first video, and the key motion has a preset motion characteristic;
a speed adjustment module 640 configured to perform speed adjustment on the first video to obtain a second video, so that at least one key motion image of the second video is in time alignment with the at least one target beat moment; and
a target on-the-beat video generation module 650 configured to add the preset music to the second video to obtain a target on-the-beat video.

In some embodiments, the second video includes a speed-adjusted video segment corresponding to each of at least one video segment of the first video; and the speed adjustment module 640 includes:
a beat moment image group determination unit configured to determine, based on a first time sequence and a second time sequence, at least one beat moment image group from the at least one key motion image and the at least one target beat moment, wherein each beat moment image group includes at least one target beat moment and at least one key motion image which are in one-to-one correspondence, the first time sequence is a time sequence of the at least one key motion image of the first video, and the second time sequence is a time sequence of the at least one target beat moment in the preset music;
a video segmenting processing unit configured to segment, based on time information of the key motion image in the at least one beat moment image group in the first video, the first video to obtain the at least one video segment, wherein each video segment includes one key motion image; and
a speed adjustment unit configured to perform, for each beat moment image, speed adjustment on the video segment where the key motion image in the beat moment image group is located to obtain a speed-adjusted video segment of the video segment, so that the key motion image in the speed-adjusted video segment is in time alignment with the target beat moment in the beat moment image group.

In some embodiments, the speed adjustment unit includes:
a time length determination unit configured to determine a music time length of the target beat moment in the beat moment image group and a video time length of the video segment where the key motion image in the beat moment image group is located;
a speed variation rate determination unit configured to determine, based on the music time length and the video time length, a speed variation rate of the video segment; and
a first speed adjustment subunit configured to perform, based on the speed variation rate, speed adjustment on the video segment to obtain the speed-adjusted video segment of the video segment.

In some embodiments, the first speed adjustment subunit includes:
an initial speed variation curve generation unit configured to generate, based on the speed variation rate, an initial speed variation curve of the video segment;
a smoothing processing unit configured to smooth the initial speed variation curve to obtain a target speed variation curve of the video segment; and
a second speed adjustment subunit configured to perform, based on the target speed variation curve, speed adjustment on the video segment to obtain the speed-adjusted video segment of the video segment.

In some embodiments, when a first number is less than a second number, the number of the at least one beat moment image group is equal to the first number, the first number is the number of the at least one target beat moment, and the second number is the number of the at least one key motion image. The above apparatus further includes:
a key motion image screening module configured to screen out, according to the first time sequence, key motion images that have the first number and come first in the first time sequence from the at least one key motion image; and
a beat moment image group determination unit configured to group, according to the first time sequence and the second time sequence, key motion images having the first number and target beat moments having the first number to obtain beat moment image groups having the first number.

In some embodiments, when the first number is less than the second number, the number of the at least one beat moment image group is equal to the first number, the first number is the number of the at least one target beat moment, and the second number is the number of the at least one key motion image. The above apparatus further includes:
an motion analysis module configured to perform motion analysis on key motion images having the second number to obtain a motion analysis result, wherein the motion analysis result represents an motion exciting level of key motion images having the second number; and
a key motion image filtering module configured to filter, based on the motion analysis result, key motion images having the second number to obtain key motion images having the first number; and
a beat moment image group determination unit configured to group, according to the first time sequence and the second time sequence, key motion images having the first number and target beat moments having the first number to obtain beat moment image groups having the first number.

In some embodiments, when the first number is greater than the second number, the number of the at least one beat moment image group is the second number, the first number is the number of the at least one target beat moment, and the second number is the number of the at least one key motion image. The above apparatus further includes:
a target beat moment screening module configured to screen out, according to the second time sequence, target beat moments that have the second number and come first in the second time sequence from the at least one target beat moment; and
a beat moment image group determination unit configured to group, according to the first time sequence and the second time sequence, key motion images having the second number and corresponding target beat moments to obtain beat moment image groups having the second number.

In some embodiments, the preset music is template music including a preset rhythm mark; and the target beat moment determination module 620 includes:
a first target beat moment determination unit configured to determine, based on the preset rhythm mark, the at least one target beat moment.

In some embodiments, the target beat moment determination module 620 includes:
an energy waveform acquisition unit configured to obtain an energy waveform of the preset music, wherein the energy waveform represents loudness information of the preset music; and
a second target beat moment determination unit configured to determine, based on the energy waveform, the at least one target beat moment.

In some embodiments, the above apparatus further includes:
an energy waveform display unit configured to display the energy waveform, wherein the energy waveform includes mark information of the at least one target beat moment; and
a target beat moment update unit configured to update, in response to an update instruction for the mark information of any target beat moment, the target beat moment corresponding to the update instruction in the at least one target beat moment.

In some embodiments, the key motion recognition module 630 includes:
acquisition unit configured to obtain a plurality of frames of video image of the first video;
an object area image extraction unit configured to extract an object area image of the moving object in the frames of video image;
an motion characteristic extraction unit configured to perform motion characteristic extraction on the object area image to obtain a plurality of pieces of motion characteristic information, wherein the motion characteristic information is configured to represent motion characteristics of the moving object in the object area image; and
a key motion image determination unit configured to determine, based on the plurality of pieces of motion characteristic information, the at least one key motion image from the frames of video image.

With regard to the apparatus in the above embodiments, the specific way in which respective modules perform operations has been described in detail in the method embodiments, and will not be described in detail here.

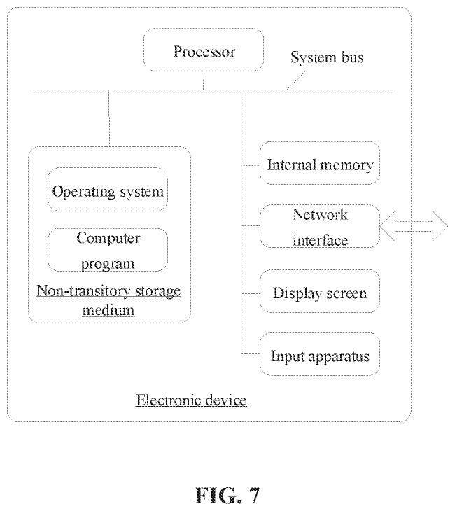

FIG. 7 is a block diagram of an electronic device for generating an on-the-beat video according to some embodiments. The electronic device may be a terminal, and its internal structure diagram may be as shown in FIG. 7. The electronic device includes a processor, a memory, a network interface, a display screen and an input apparatus which are connected through a system bus. The processor of the electronic device is configured to provide computing and control capabilities. The memory of the electronic device includes a non-transitory storage medium and an internal memory. The non-transitory storage medium stores an operating system and a computer program. The internal memory provides an environment for operation of the operating system and the computer program in the non-transitory storage medium. The network interface of the electronic device is configured to communicate with an external terminal through network connection. The computer program, when executed by a processor, implements a method for generating an on-the-beat video. The display screen of the electronic device may be a liquid crystal display screen or an electronic ink display screen, and the input apparatus of the electronic device may be a touch layer covering the display screen, and may also be a button, a trackball or a touchpad disposed on a shell of the electronic device, or an external keyboard, touchpad or mouse, etc.

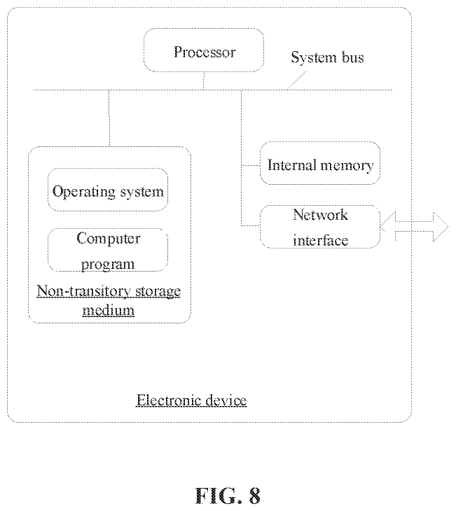

FIG. 8 is a block diagram of an electronic device for generating an on-the-beat video according to some embodiments. The electronic device may be a server, and its internal structure diagram may be as shown in FIG. 8. The electronic device includes a processor, a memory and a network interface which are connected through a system bus. The processor of the electronic device is configured to provide computing and control capabilities. The memory of the electronic device includes a non-transitory storage medium and an internal memory. The non-transitory storage medium stores an operating system and a computer program. The internal memory provides an environment for operation of the operating system and the computer program in the non-transitory storage medium. The network interface of the electronic device is configured to communicate with an external terminal through network connection. The computer program, when executed by a processor, implements the following steps:
acquiring a first video and preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

In some embodiments, the second video includes a speed-adjusted video segment corresponding to each of at least one video segment of the first video;
performing the speed adjustment on the first video to obtain the second video includes:
determining, based on a first time sequence and a second time sequence, at least one beat moment image group from the at least one key motion image and the at least one target beat moment, wherein each beat moment image group includes at least one target beat moment and at least one key motion image which are in one-to-one correspondence, the first time sequence is a time sequence of the at least one key motion image of the first video, and the second time sequence is a time sequence of the at least one target beat moment in the preset music;
segmenting, based on time information of the key motion image in the at least one beat moment image group in the first video, the first video to obtain the at least one video segment, wherein each video segment includes one key motion image; and
performing, for each beat moment image group, speed adjustment on the video segment where the key motion image in the beat moment image group is located to obtain a speed-adjusted video segment of the video segment, so that the key motion image in the speed-adjusted video segment is in time alignment with the target beat moment in the beat moment image group.

In some embodiments, performing the speed adjustment on the video segment where the key motion image in the beat moment image group is located to obtain the speed-adjusted video segment corresponding to the video segment includes:
determining a music time length of the target beat moment in the beat moment image group and a video time length of the video segment where the key motion image in the beat moment image group is located;
determining, based on the music time length and the video time length, a speed variation rate of the video segment; and
performing, based on the speed variation rate, speed adjustment on the video segment to obtain the speed-adjusted video segment of the video segment.

In some embodiments, performing, based on the speed variation rate, speed adjustment on the video segment to obtain the speed-adjusted video segment of the video segment includes:
generating, based on the speed variation rate, an initial speed variation curve of the video segment;
smoothing the initial speed variation curve to obtain a target speed variation curve of the video segment; and
performing, based on the target speed variation curve, speed adjustment on the video segment to obtain the speed-adjusted video segment of the video segment.

In some embodiments, when a first number is less than a second number, the number of the at least one beat moment image group is equal to the first number, the first number is the number of the at least one target beat moment, and the second number is the number of the at least one key motion image;
the method further includes:
screening out, according to the first time sequence, key motion images that have the first number and come first in the first time sequence from the at least one key motion image; and
determining, based on the first time sequence and the second time sequence, the at least one beat moment image group from the at least one key motion image and the at least one target beat moment includes:
grouping, according to the first time sequence and the second time sequence, key motion images having the first number and target beat moments having the first number to obtain beat moment image groups having the first number.

In some embodiments, when the first number is less than the second number, the number of the at least one beat moment image group is equal to the first number, the first number is the number of the at least one target beat moment, and the second number is the number of the at least one key motion image;
the method further includes:
performing motion analysis on key motion images having the second number to obtain an motion analysis result, wherein the motion analysis result represents an motion exciting level of key motion images having the second number; and
filtering, based on the motion analysis result, key motion images having the second number to obtain key motion images having the first number; and
determining, based on the first time sequence and the second time sequence, the at least one beat moment image group from the at least one key motion image and the at least one target beat moment includes:
grouping, according to the first time sequence and the second time sequence, key motion images having the first number and target beat moments having the first number to obtain beat moment image groups having the first number.

In some embodiments, when the first number is greater than the second number, the number of the at least one beat moment image group is the second number, the first number is the number of the at least one target beat moment, and the second number is the number of the at least one key motion image;
the method further includes:
screening out, according to the second time sequence, target beat moments that have the second number and come first in the second time sequence from the at least one target beat moment; and
determining, based on the first time sequence and the second time sequence, the at least one beat moment image group from the at least one key motion image and the at least one target beat moment includes:
grouping, according to the first time sequence and the second time sequence, key motion images having the second number and corresponding target beat moments to obtain beat moment image groups having the second number.

In some embodiments, the preset music is template music including a preset rhythm mark; and
determining the at least one target beat moment in the preset music includes:
determining, based on the preset rhythm mark, the at least one target beat moment.

In some embodiments, determining the at least one target beat moment in the preset music includes:
acquiring an energy waveform of the preset music, wherein the energy waveform represents loudness information of the preset music; and
determining, based on the energy waveform, the at least one target beat moment.

In some embodiments, the method further includes:
displaying the energy waveform, wherein the energy waveform includes mark information of the at least one target beat moment; and
updating, in response to an update instruction for the mark information of any target beat moment, the target beat moment corresponding to the update instruction in the at least one target beat moment.

In some embodiments, performing key motion recognition on the first video to obtain the at least one key motion image of the first video includes:
acquiring a plurality of frames of video image of the first video;
extracting an object area image of the moving object in the frames of video image;
performing motion characteristic extraction on the object area image to obtain a plurality of pieces of motion characteristic information, wherein the motion characteristic information is configured to represent motion characteristics of the moving object in the object area image; and
determining, based on the plurality of pieces of motion characteristic information, the at least one key motion image from the frames of video image.

It can be understood by those skilled in the art that the structure shown in FIG. 7 or FIG. 8 is only a block diagram of part of the structure related to the solution of the present disclosure, and does not constitute a limitation on the electronic device to which the solution of the present disclosure is applied. The specific electronic device may include more or less components than those shown in the figures, or combine some components, or have different component arrangements.

In an exemplary embodiment, an electronic device is also provided and includes a processor and a memory for storing instructions executable by the processor; wherein the processor is configured to execute the instructions to implement the method for generating an on-the-beat video according to the embodiments of the present disclosure.

In an exemplary embodiment, a computer-readable storage medium is also provided. The instructions in the storage medium, when executed by a processor of an electronic device, enable the electronic device to be capable of executing the method for generating an on-the-beat video according to the embodiments of the present disclosure.

In an exemplary embodiment, a computer program product including instructions is also provided, and, when running on a computer, enables the computer to execute the method for generating an on-the-beat video according to the embodiments of the present disclosure.

It can be understood by those ordinary skilled in the art that all or part of the processes in the method according to the above embodiments can be completed by instructing related hardware through a computer program, the computer program can be stored in a non-transitory computer-readable storage medium, and the computer program, when executed, can include the processes of the above respective method embodiments. Any reference to the memory, storage, database or other mediums used in respective embodiments according to the present application can include a non-transitory and/or a volatile memory. The non-transitory memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. By way of illustration and not limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), a memory bus dynamic RAM (RDRAM), etc.

All embodiments of the present disclosure can be executed separately or in combination with other embodiments, which are regarded as the protection scope of the present disclosure.

What is claimed is:

1. A method for generating an on-the-beat video, comprising:
acquiring a first video and acquiring preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

2. The method according to claim 1, wherein the second video comprises a speed-adjusted video segment corresponding to each of at least one video segment of the first video;
performing the speed adjustment on the first video to obtain the second video comprises:
determining, based on a first time sequence and a second time sequence, at least one beat moment image group from the at least one key motion image and the at least one target beat moment, wherein each beat moment image group comprises at least one target beat moment and at least one key motion image which are in one-to-one correspondence, the first time sequence is a time sequence of the at least one key motion image of the first video, and the second time sequence is a time sequence of the at least one target beat moment in the preset music;
segmenting, based on time information of the key motion image in the at least one beat moment image group in the first video, the first video to obtain the at least one video segment, wherein each video segment comprises one key motion image; and
performing, for each beat moment image group, speed adjustment on a video segment where a key motion image in the beat moment image group is located to obtain a speed-adjusted video segment of the video segment, so that the key motion image in the speed-adjusted video segment is in time alignment with a corresponding target beat moment in the beat moment image group.

3. The method according to claim 2, wherein performing the speed adjustment on the video segment where the key motion image in the beat moment image group is located to obtain the speed-adjusted video segment corresponding to the video segment comprises:
determining a music time length of the corresponding target beat moment in the beat moment image group and a video time length of the video segment where the key motion image in the beat moment image group is located;
determining, based on the music time length and the video time length, a speed variation rate of the video segment; and
performing, based on the speed variation rate, speed adjustment on the video segment to obtain the speed-adjusted video segment of the video segment.

4. The method according to claim 3, wherein performing, based on the speed variation rate, speed adjustment on the video segment to obtain the speed-adjusted video segment of the video segment comprises:
generating, based on the speed variation rate, an initial speed variation curve of the video segment;
smoothing the initial speed variation curve to obtain a target speed variation curve of the video segment; and
performing, based on the target speed variation curve, speed adjustment on the video segment to obtain the speed-adjusted video segment of the video segment.

5. The method according to claim 2, wherein when a first number is less than a second number, a number of the at least one beat moment image group is equal to the first number, wherein the first number is a number of the at least one target beat moment, and the second number is a number of the at least one key motion image;
the method further comprises:
screening out, according to the first time sequence, key motion images that have the first number in the first time sequence from the at least one key motion image; and
determining, based on the first time sequence and the second time sequence, the at least one beat moment image group from the at least one key motion image and the at least one target beat moment comprises:
grouping, according to the first time sequence and the second time sequence, the key motion images having the first number and corresponding target beat moments having the first number to obtain beat moment image groups having the first number.

6. The method according to claim 2, wherein when a first number is less than a second number, a number of the at least one beat moment image group is equal to the first number, wherein the first number is a number of the at least one target beat moment, and the second number is a number of the at least one key motion image;
the method further comprises:
performing motion analysis on key motion images having the second number to obtain an motion analysis result, wherein the motion analysis result represents a motion exciting level of the key motion images having the second number; and
filtering, based on the motion analysis result, key motion images having the second number to obtain key motion images having the first number, and the filtered key motion images includes key motion images with a greater exciting level;
and, determining, based on the first time sequence and the second time sequence, the at least one beat moment image group from the at least one key motion image and the at least one target beat moment comprises:
grouping, according to the first time sequence and the second time sequence, the key motion images having the first number and corresponding target beat moments having the first number to obtain beat moment image groups having the first number.

7. The method according to claim 2, wherein when a first number is greater than a second number, a number of the at least one beat moment image group is equal to the second number, wherein the first number is a number of the at least one target beat moment, and the second number is a number of the at least one key motion image;
the method further comprises:
screening out, according to the second time sequence, target beat moments that have the second number and come first in the second time sequence from the at least one target beat moment;
determining, based on the first time sequence and the second time sequence, the at least one beat moment image group from the at least one key motion image and the at least one target beat moment comprises:
grouping, according to the first time sequence and the second time sequence, key motion images having the second number and corresponding target beat moments having the second number to obtain beat moment image groups having the second number.

8. The method according to claim 1, wherein the preset music is template music comprising a preset rhythm mark; and
determining the at least one target beat moment in the preset music comprises:
determining, based on the preset rhythm mark, the at least one target beat moment.

9. The method according to claim 1, wherein determining the at least one target beat moment in the preset music comprises:
acquiring an energy waveform of the preset music, wherein the energy waveform represents loudness information of the preset music; and
determining, based on the energy waveform, the at least one target beat moment.

10. The method according to claim 9, wherein the method further comprises:
displaying the energy waveform, wherein the energy waveform comprises mark information of the at least one target beat moment; and
updating, in response to an update instruction for mark information of any target beat moment, a target beat moment corresponding to the update instruction in the at least one target beat moment.

11. The method according to claim 1, wherein performing key motion recognition on the first video to obtain the at least one key motion image of the first video comprises:
acquiring a plurality of frames of video image of the first video;
extracting an object area image of the moving object in the plurality of frames of video image of the first video;
performing motion characteristic extraction on the object area image to obtain a plurality of pieces of motion characteristic information, wherein the motion characteristic information is configured to represent motion characteristics of the moving object in the object area image; and
determining, based on the pieces of motion characteristic information, the at least one key motion image from the plurality of frames of video image of the first video.

12. An electronic device comprising:
a processor; and
a memory for storing instructions executable by the processor;
wherein the processor is configured to execute the instructions to implement the following steps:
acquiring a first video and acquiring preset music;
determining at least one target beat moment in the preset music;
performing key motion recognition on the first video to determine at least one key motion image of the first video, wherein the key motion recognition is used to recognize a key motion of a moving object in the first video, and the key motion has a preset motion characteristic;
performing speed adjustment on the first video to obtain a second video, so that at least one key motion image of the second video is in time alignment with the at least one target beat moment; and
adding the preset music to the second video to obtain a target on-the-beat video.

13. A method for generating an on-the-beat video, implemented in an electronic device, the method comprising:
acquiring a first video and acquiring preset music in response to import, by a user, on a video editing page displayed on the electronic device;
determining at least one target beat moment in the preset music in response to a user's operation on mark information on the preset music or determined automatically based on a music template;
identifying at least one key motion image of the first video by a neural network trained to recognize the key motion image;
determining at least one beat moment image group from the at least one target beat moment and the at least one key motion image based on a number of target beat moments in the preset music and a number of key motion images in the first video such that one target beat moment corresponds one key motion image, wherein a number of the at least one beat moment image group is equal to the smaller one of the number of target beat moments in the preset music and the number of key motion images in the first video;
adjusting a speed of the first video such that the at least one key motion image in the at least one beat moment image group is in time alignment with the at least one target beat moment in the at least one beat moment image group; and
adding the preset music to the adjusted first video to obtain the on-the-beat video.

14. The method of claim 13, wherein the mark information is a mark on an energy waveform of the preset music.

15. The method of claim 13, wherein the mark information is a rhythm mark on a template music in a case that the preset music is the template music.
